(19) United States
(12) Patent Application Publication
(10) Pub. No.: US 2013/0253968 A1
(43) Pub. Date: Sep. 26, 2013

(54) FACILITY CONTROL SYSTEM (FCS, C1) TO MANAGE ASSETS PLANNING, DESIGN, CONSTRUCTION, FABRICATION, OPERATING, MAINTENCE AND PRODUCTS

(71) Applicants: David Frederick Martinez, (US); Elias George EL-Dahdah, (US); Chuang-Tsair Shih, (US)

(72) Inventors: David Frederick Martinez, (US); Elias George EL-Dahdah, (US); Chuang-Tsair Shih, (US)

(21) Appl. No.: 13/429,651

(22) Filed: Mar. 26, 2012

(51) Int. Cl. G06Q 10/06

(52) U.S. Cl. 705/7.12

(57) ABSTRACT

A facility control system includes lab, field and construction equipment with a wireless transceiver to transmit machine generated actual initial measurement (AIM) data including GPS information from a field activity to a wide area network; a mobile computer with a wireless transceiver to transmit human generated data from an office, a remote lab, or a field test or inspection to the network; and a server coupled to the network, the server including a database to receive machine and human generated AIM data, wherein the server applies statistics and engineering methods to predict specification compliance and performance, wherein the AIM data is used with pre-formatted engineered designed data sheets that reflect the exact location of the event and required standards including incorporating best construction practices for installation of one or more construction items and materials quality to promote standardization, uniformity that insures contract compliance and minimizes non-conforming items in real time.

### BACKGROUND

Historically owners/agencies and parts of the management team have been responsible for managing large capital programs from the conceptual, planning, design, construction, operation and maintenance. These programs include horizontal and vertical facilities, ranging from roads, bridges, water lines, sewer lines, overlays, sidewalks to variety of building including energy related facilities, fabrication of equipment for use in a facility and office buildings. Program managers were unable to determine the “true” real time status of the life cycles of each component in the capital improvement program (CIP). Project managers have relied on untimely, invalidated and incorrect information to manage engineering and construction programs. The use of incomplete and inaccurate static data sheets and information that is dated has been the norm in managing projects for the last 200 years. A long term need was to secure real time accurate validated and formatted in best practices review reports information from the entire program management and various construction teams, including field personnel that can assist in the daily decisions that are needed to control the work, cost, schedule and quality as well administrative reporting requirements for each component of the CIP.

### SUMMARY

A facility control system includes lab equipment with a wireless transceiver to transmit machine generated actual initial measurement (AIM) data from a field test to a wide area network; a mobile computer with a wireless transceiver to transmit human generated data from an office, a remote lab, or a field test to the network; and a server coupled to the network, the server including a database to receive machine and human generated AIM data, wherein the server applies statistics and engineering methods to predict specification compliance and performance, wherein the AIM data is used with pre-formatted engineered designed data sheets that reflect the required standards and best practices including incorporating best construction practices for installation of one or more construction items and materials quality to promote standardization, uniformity that insures contract compliance and minimizes non-conforming items, wherein the AIM and actual final measurement (AFM) data is calculated on the server over the network in real time, wherein the server, lab equipment, and mobile computer form a systematic approach to provide real time dynamic reports regarding one or more components of a capital improvement program (CIP) or similar; wherein the systematic approach enables one or more construction teams to generate dynamic reports in real time with best practice engineered designed data sheets for installation and testing of project activities and construction items, and wherein the systematic approach supports indexing of complete project specific data to facilitate document retrieval and project collaboration.

Advantages of the preferred embodiments may include one or more of the following. The final data can be computed and shared with all project team members using the WAN. The FCS is a systematic approach for multiple projects, regardless of their stage in the life cycle process including but not limited planning, design, construction, operation, maintenance, inspection, testing laboratories and various processes and manufactured construction materials real time on the project cost, schedule, and quality assurance. The status of a given project activity, including cost, schedule and quality can be determined in real time and be shared among all project team members. The system provides a complete view from all sources of data including AIM data collected by a human operator or laboratory, field and/or construction equipment. Such information links the entire management, engineer and construction team by use of a computer mobile or stationary that have been formatted with “raw” data sheets which have been designed to collect initial data that conforms to industry best practices such that contract compliance with required project standards is determined, management reports are readily available, dynamic reports can be viewed by the entire team in real time. The pre-engineered raw data sheets formatted for best practices are designed to be indexed in a manner that facilitates expedite quick and accurate retrieval and collaboration between all team members.

The system allows AIM and AFM to be calculated in a WAN in real time. The AIM data pre-formatted data sheets incorporate best engineering and construction practices for installation and materials quality to promote standardization, uniformity and insure contract compliance and minimize the occurrence of non-conforming items. In addition, the FCS approach implements a preventative systematic approach to minimize the effort in final project commissioning. Furthermore, the AIM checklist can be are formatted on a mobile device or another other type of computer to facilitate the rollup of field data and all sources of data that occurring throughout the construction team various site office and other project locations.

The AIM engineered designed best practices standard forms are designed such that the data collected results in compliance with industry best practices and in addition to specification compliance. The use of “raw” pre-engineered best practice data sheets formatted for a human to enter data directly on a GIS map enables accurate 3D locations and associated data.

Potential Sources of AIM Data may include:

1. Data directly entered into a GIS map with pre-formatted data sheets

2. Data from Office Engineer/Project Manager desk top computer

3. Planning, Design and Construction managers and engineers, technicians and administrators use of a computer

4. Construction testers and inspectors use of computers with preformatted engineered designed “raw” data sheets that encourage best practices in the industries such that “real time” status is determine, contract compliance, non-conformance items is also minimized

5. Laboratory equipment and construction field equipment are also a source of AIM data

6. Operations can also transfer AIM data directly into a WAN

7. Maintenance operations can also transfer AIM data directly into a WAN

8. Photographs, Video clips. Sketches of current site conditions

9. Data entered using a mobile field device

The AFM can be calculated according to industry standards and/or management preferences. The AFM dynamic reports have been validated, presented in best practices format and available in real time. The indexed AFM reports are dynamic and provide “true” real time status reports. The AFM reports can also be viewed in a GIS Map that permits the instant retrieval of “raw” AIM data. The Indexed AFM data provides a list of daily activities, dynamic reports, list of active NCR and initiates the NCR report process. The AFM data is used to determine compliance with project design, construction, operations and maintenance requirements, cost control, schedule control and regularity compliance. The data viewing rights are controlled in the system. The AFM are also presented on pre-design dynamic performance reports that allow trending and provide the manager the ability to avoid non-conformance and costly re-work. Alarming trends or non-conformance would be available to the management team in “true” real time. The results can be posted by the use of GIS map and facilitate data retrieval and analysis. In addition, since the AIM data is easily retrieved in the index system the resolution and management response and appropriate action is easily addressed. The data includes engineering data, photographs and video of actual conditions. Access to all data assist in providing a real time evaluation of the actual facility. The construction team has a dynamic environment that permits viewing of selected data and reports in “true” real-time. The current state of the art is linear viewing with many point to point interruptions (silos), rather than an integrated solution with real time information that has been designed to regulate inflow, outflow and final indexing. Pin point coordinates in 3D allow a unique view in graphical format.

The use of GIS pre-engineered best practiced “raw” data sheets allow the results to be viewed on a GIS map with exact coordinates pin-pointed from GPS. There the AIM and AFM data, reports are clearly identified by their respective locations with GPS assistance. The collection of AIM and AFM data can be view in 3D using the a,y,z coordinates. The collected data can be retrieved from a GIS map with specific spatial coordinates. The collected information can be retrieved and viewed from a GIS map with AIM and AFM information.

This feature provides a unique efficient systematic approach to reviewing final data and its supporting documentation. This feature will also provide improved characterization of site conditions for future design and construction projects.

The AIM data is input and AFM data is calculated in the WAN and readily available to the program managers and various project team members. In addition, the filing of the final data is pre indexed which facilitate retrieval and allow dynamic viewing that is being able to view the specific report or item at your convenience via the internet. The data includes engineering data, photographs and video of actual conditions. Access to all data assist in providing a real time evaluation of the actual facility. The construction team has a dynamic environment that permits viewing of selected tops and details related in “true” real-time. The current state of the art is linear viewing with many point to point interruptions (silos), rather than an integrated solution.

### BRIEF DESCRIPTION OF THE DRAWINGS

FIG. 1 Facility Control System (FCS) Construction Process

FIG. 2 Exemplary Process of GIS and GPS Integration

### DESCRIPTION

Construction Activities

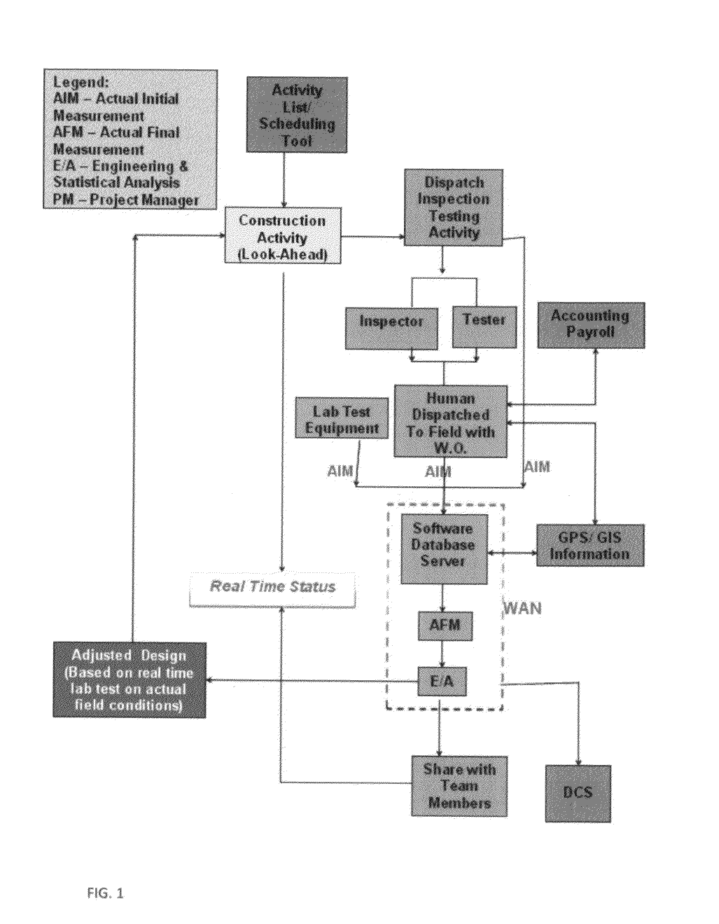

FIG. 1 illustrates shows an exemplary system through construction management process system. The system provides an integrated solution that provides one silo for all the data functions and will allow for quick retrieval of real-time data. This will increase operational efficiencies by removing latency in the work flow processes. Construction activities are identified through some communication portal such as, scheduling software, construction activities data base, list of construction activities, et. al. The invention permits the connection between construction activities and “true” site conditions communicated via field and/or lab equipment. The data is collected, calculated and analyzed in real time, design can then re-adjust their designs and communicate the revised designs to construction personal in real time. The entire processes occur in a web server.

Dispatch Field Human Resources (HR) Needs based on Construction: Activities

Construction activities are identified and corresponding field human resources needs are identified such as inspectors, auditors, testers, engineers, sampler, etc. to conduct contract required functions, such as inspections, tests, audits, . . . etc. The field personal/with required and necessary information and equipment is dispatched with a detailed work order that is linked to a specific construction activity with specific instruction as to the task at hand, required specifications, test frequency, specification and criteria. The work order also provides a hyper link to the project location and other related project information and also records the details regarding the field specific location in x,y,z by GPS. The work order also serves as a time sheet to record employee payroll information. This collected AIM and calculated AFM data information can be retrieved through a GIS map.

HR Field Services Recorded in Web Server

Field activities are collected using a mobile computer and whereas preformatted data sheets are used such that AIM information collected is pre-indexed recorded in the mobile device and whereas the AFM are calculated in the web server. The information is available in real time in the web server and available to the project team via the web. The collected data is pre-indexed and automatically indexed with in a document control system.

Real Time Viewing AIM Data

The various functions from construction throughout process to the AFM reports can be monitored in real time. The AIM data can result from human and or equipment. The AFM are calculated in the web.

Real Time AIM/AFM Used to Change Designs

Based on this real time information and the actual field conditions can be altered to reflect actual field conditions. The field change and ultimate design change can occur as a result of this real time information.

GIS and GPS Integration

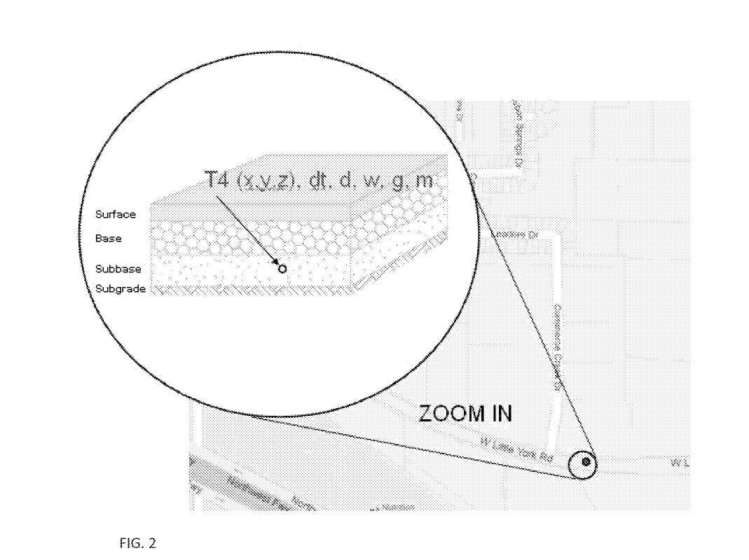

FIG. 2 shows an exemplary process to provide the exact location for construction activities. The system is the integration of GIS and GPS. The activity location is displayed on the map in real time by using GIS system. The location can also be magnified with tools of zooming to show detailed surroundings. The exact position then is displayed with 3D pane by using GPS system. Results of AIM and AFM from the construction activities are available to retrieve in real time and display on 3D graph and/or illustration.

The construction data may be reviewed in real time in three dimensions. Real-time “As-builds” can review and future construction can be modeled. The invention also allows spatial relationships, or specifies how some objects, activities or inspections are located in space both in directional and distance. The construction activities, inspections and test can be defined as parameters and their relations to other objects therefore actual activities completed, forecast required activities and thereby adjusting the needs in real time.

The concept of the 3D mapping is similar to BIM (Building Information Modeling). BIM is a process of generating and managing building data and involves representing a design as objects that carry the geometry, relations and attributes. Typically BIM uses three-dimensional, real-time, dynamic building modeling tool to increase productivity in building design and construction.

Once the location of the activity is selected, the exact position can be zoomed in to reveal the results and information in real time. Those results include AIM and AFM which are collected from different field devices. The results and information includes, but not limited to the followings, x-, y- and z-coordinates, activity date/time (dt), nuclear gauge density (d), moisture content (w), gradation (g), and mix design (m) as shown in FIG. 2 at location T4.

What is claimed is:

1. A facility control system, comprising:
lab and field equipment with a wireless transceiver to transmit machine generated actual initial measurement (AIM) data from a field activities, inspection and tests to a wide area network;
a mobile computer with a wireless transceiver to transmit human generated data from an office, remote construction site, a remote lab, or an inspection or field test to the network;
the mobile logs the AIM data with GPS for 3D identification and AIM/AFM data is accessible through a GIS and
a server coupled to the network, the server including a central database to receive machine and human generated AIM data, wherein the server applies statistics and engineering methods to predict specification compliance and performance, wherein the AIM and AFM data is used with pre-formatted engineered designed data sheets and dynamic reporting that reflect the required standards and best practices including incorporating best construction practices for installation of one or more construction items and materials quality to promote standardization, uniformity that insures contract compliance and minimizes non-conforming items, wherein the AIM and AFM data is calculated on the server over the network in real time,
wherein the server, lab equipment, and mobile computer form a systematic approach to provide real time dynamic reports regarding one or more components of a capital improvement program (CIP); wherein the systematic approach enables one or more construction teams to generate dynamic reports in real time with best practice engineered designed data sheets for installation and testing of project activities and construction items, and wherein the systematic approach supports indexing of complete project specific data to facilitate document retrieval, project collaboration and the roll-up of the various projects in a program and or a portfolio.

2. The system of claim 1, wherein final data is calculated on the server and shared with project team members over the network.

3. The system of claim 1, wherein the server stores data in the central database for monitoring multiple projects or programs, regardless of their stage in the life cycle.

4. The system of claim 1, wherein the server stores data relating to planning, design, construction, operation, maintenance, inspection, testing laboratories and various processes and manufactured construction materials real time on the project cost, schedule, and quality assurance.

5. The system of claim 1, wherein the status of a given project activity quality can be determined in real time and be shared among all project team members.

6. The system of claim 1, comprising a integrated project management module coupled to a centralized database.

7. The system of claim 6, comprising:
a document control system;
an accounting system;
a scheduling system; and
a geographical information system (GIS).

8. The system of claim 6, comprising a planning module, a design module, a construction module, a maintenance module, and an operations module.

9. The system of claim 6, comprising an audit module, an estimating/scheduling module, an inspection module, and a testing module.

10. The system of claim 1, wherein the database captures actual final measurement (AFM).

11. The system of claim 1, wherein the statistics and engineering methods comprise aggregate, asphalt, concrete and soil tests and all types of construction materials.

12. The system of claim 1, comprising a plurality of pre-formatted forms stored in the mobile computer.

13. The system of claim 12, comprising a field engineering form to capture a cost, a schedule, labor, equipment and a quantity.

14. The system of claim 12, comprising an inspector form to capture a work activity, a daily report and a “checklist” designed with consideration of required standards, indexing logs and consideration of best practices installation report.

15. The system of claim 12, comprising a tester form to capture laboratory and field test data.

16. The system of claim one receive information form the construction schedule and activity log to forecast and dispatch human and mechanical equipment needs to insure field activities and compliance is logged using mobile devices.

17. The system of claim 1, wherein the database stores GIS and GPS data along with AIM data or human generated field data, and calculated or generated AFD or reports.

18. The system of claim 1, AIM data resulting from audits, engineered workmanship checklist and test data sheets are calculated in the web server, systematically logged and retrievable through the use of GIS maps and viewed in 3D.

19. The system of claim 1, provides real time AIM data thereby allowing the designers to modify their original designs based on actual field conditions

20. The system of claim 1, wherein the server runs a preventative systematic checklist to minimize the length of a punch list or a list of non-compliant items therefore facilitating the project commissioning.

21. The system of claim 1, wherein the checklist is formatted on a mobile device to facilitate a rollup of field data and other sources of data occurring throughout the construction team, one or more site offices, and one or more project locations.
